(19) United States
(12) Patent Application Publication
(10) Pub. No.: US 2009/0157362 A1
(43) Pub. Date: Jun. 18, 2009

(54) MODEL MODIFICATION METHOD FOR A SEMICONDUCTOR DEVICE

(76) Inventors: Yu-Lin Wu, Hsinchu Science Park (TW); Hsin-Lan Chang, Hsinchu Science Park (TW); Sheng-Yow Chen, Hsinchu Science Park (TW)

Correspondence Address: Muncy, Geissler, Olds & Lowe, PLLC, P.O. BOX 1364, FAIRFAX, VA, 22038-1364, US

(21) Appl. No.: 12/336,212

(22) Filed: Dec. 16, 2008

Related U.S. Application Data
(60) Provisional application No. 61/014,603, filed on Dec. 18, 2007.

(51) Int. Cl. G06G 7/48

(52) U.S. Cl. 703/7

(57) ABSTRACT

A model modification method for a semiconductor device comprises the steps of: analyzing the electrical properties of a goal semiconductor device, in detail, to build a goal model that can be used to describe the behavior of the goal semiconductor device; and modifying the goal model according to the results of the WAT to obtain a modified model that can be used accurately to describe the behavior of produced semiconductor devices.

### FIELD OF THE INVENTION

The present invention relates to a model modification method for a semiconductor device, wherein the goal model of the goal semiconductor device can be modified for accurately describing the behavior of produced semiconductor devices.

### BACKGROUND OF THE INVENTION

As IC designers develop or design an integrated circuit, they have to communicate with the foundry, and both can provide each other with relative information. Thereby, IC designers can design the integrated circuit with information provided from the foundry; as well, the foundry can improve the yield and reliability of produced semiconductor devices.

Referring to FIG. 1, a flow chart of an analysis process for semiconductor devices in accordance with prior art is shown. The foundry would produce a goal semiconductor device according to the demand of clients and further analyze the electrical properties of the goal semiconductor device, in detail, to build a goal model. Thereafter, the foundry can provide the goal model to IC designers, as shown in step 11.

The IC designers can figure out and acquire the behavior of produced semiconductor devices through the simulation of the goal model, as shown in step 13. Thereafter, the IC designers can design the integrated circuit according to the behavior of semiconductor devices, as shown in step 15.

The foundry performs the semiconductor process according to the designed circuit, and the produced semiconductor devices are expected to comprise similar electrical properties to the goal model. However, during the semiconductor process, there were variations that occurred under various conditions, and the electrical properties of produced semiconductor devices would thusly be altered. As such, the process of simulating the goal model would be a failure because the behavior of the semiconductor device is inaccurate according to the simulation.

Since the simulation result of the goal model cannot be represented in a similar fashion to the behavior of produced semiconductor devices, the aforementioned problems will appear, and the integrated circuit that is designed by IC designers will differ from the produced integrated circuit.

### SUMMARY OF THE INVENTION

It is a primary objective of the present invention to provide a model modification method for a semiconductor device, wherein a goal model can be modified according to the results of the WAT to generate a modified model that can be used to describe the behavior of produced semiconductor devices.

It is another objective of the present invention to provide a model modification method for a semiconductor device, wherein the process defect can be discerned by the difference between the goal model and the modified model for amending the semiconductor process.

It is another objective of the present invention to provide a model modification method for a semiconductor device, wherein a plurality of results of WAT can be compiled statistics in distribution, and the goal model can be modified according to the result of the distribution statistics to generate a statistical model.

It is another objective of the present invention to provide a model modification method for a semiconductor device, wherein the statistical model can be used to figure out the distribution range of behavior for semiconductor devices.

In an aspect of the present invention, a model modification method for a semiconductor device comprises the steps of: building a goal model for describing the behavior of a goal semiconductor device; modifying the goal model according to at least one result of the WAT; and generating a modified model for describing the behavior of a produced semiconductor device.

The present invention can be best understood through the following description and accompanying drawings.

### BRIEF DESCRIPTION OF THE DRAWINGS

FIG. 1 is a flow chart of an analysis process for the semiconductor device in accordance with a prior art;

FIG. 2 is a flow chart of a model modification method for the semiconductor device in accordance with an embodiment of the present invention;

FIG. 3A to FIG. 3D are flow charts of a model modification method for the semiconductor device in accordance with an embodiment of the present invention;

FIG. 4 is a flow chart of a model modification method for the semiconductor device in accordance with another embodiment of the present invention; and

FIG. 5 is a flow chart of a model modification method for the semiconductor device in accordance with another embodiment of the present invention.

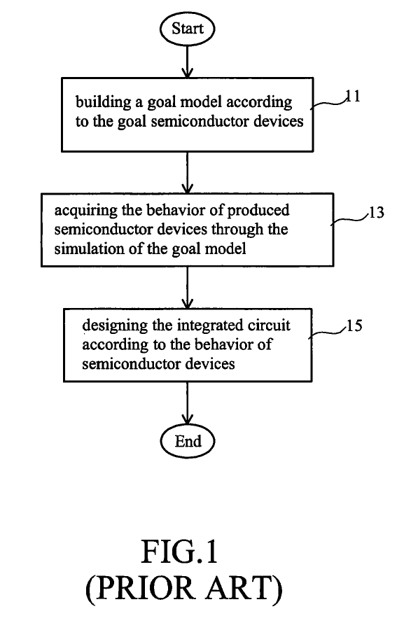

### DETAILED DESCRIPTION OF DISCLOSED EMBODIMENTS

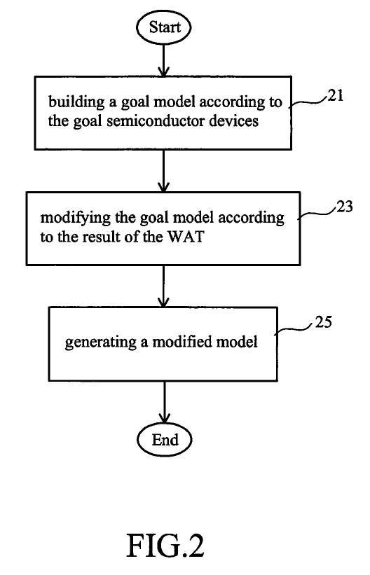

Referring to FIG. 2, a flow chart of a model modification method for semiconductor devices in accordance with an embodiment of the present invention is disclosed. The model modification method of the present invention comprises the steps of: starting a WAT (Wafer Acceptance Test) of semiconductor devices; modifying a goal model according to at least one result of the WAT; and describing the behavior of produced semiconductor devices according to a modified model.

The foundry would manufacture a batch of goal semiconductor devices, and analyze the electrical properties of goal semiconductor devices, in detail, to build a goal model for describing the behavior of goal semiconductor devices, before IC designers design an integrated circuit, as shown in step 21.

The foundry or IC designer(s) can modify the goal model according to the result of the WAT, as shown in step 23. Thereafter, a modified model can be obtained for correctly describing the behavior of produced semiconductor devices, such that IC designers can get the correct behavior of produced semiconductor devices, wherein the produced semiconductor devices can be semiconductor devices of mass production from the foundry, as shown in step 25.

The foundry could perform an aforementioned process of the WAT, and provide the result of the WAT to IC designers. Of course, the foundry could also build the modified model in accordance to the goal model and the result of the WAT. Otherwise, IC designers could perform the process of the WAT by themselves in order to get the results of WAT and build the modified model.

The behavior of produced semiconductor devices can be obtained through the simulation of a modified model. For example, the IC designers can acquire the behavior of produced semiconductor devices through the process of simulating the goal model, thus to accomplish the design of a circuit. Thereafter, the foundry can perform the process of semiconductor devices according to the designed circuit. The modified model can be used to describe the correct behavior of produced semiconductor devices, such that IC designers can achieve the integrated circuit design, and the foundry can improve the yield and reliability of produced semiconductor devices.

Otherwise, process engineers in the foundry can be aware of the process defect according to the yield and modified model, and modify the process for improving the yield of semiconductor devices. Compared with prior art, that the process defect is released from the result of the WAT and yield, the process engineers can become aware of the process defect more effectively from the modified model of the invention.

The parameters of the goal model can be adjusted according to the result of the WAT of semiconductor devices to build the modified model. That is, the IC designers can adjust the parameters, such as Tox, x1, xw, vth0, u0, K1, dvt0, dvt2, rdsw, Lint, voff1, K3, K3b, dwg, Wint, dvtow and/or ww1, through the results of the WAT.

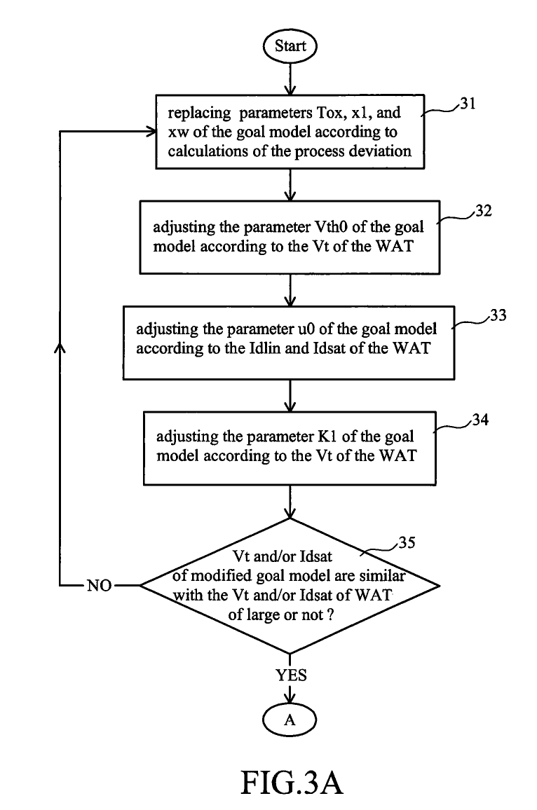

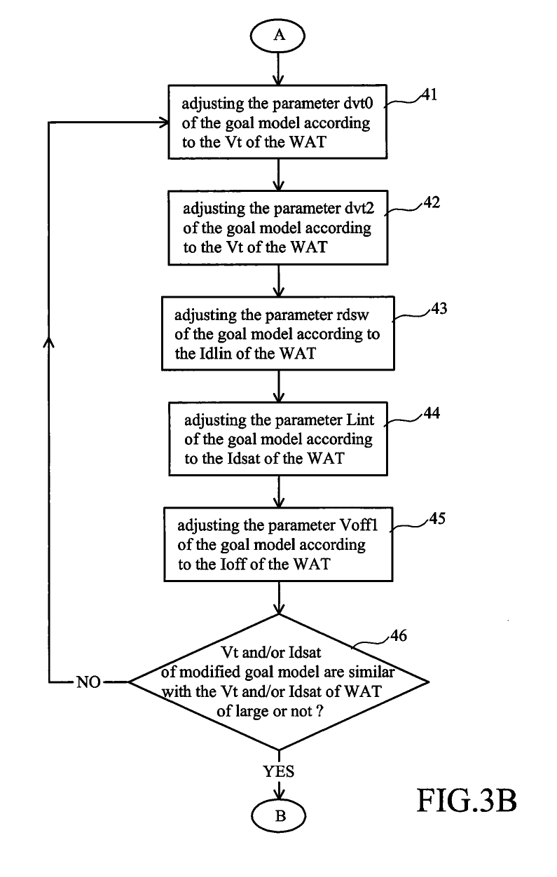

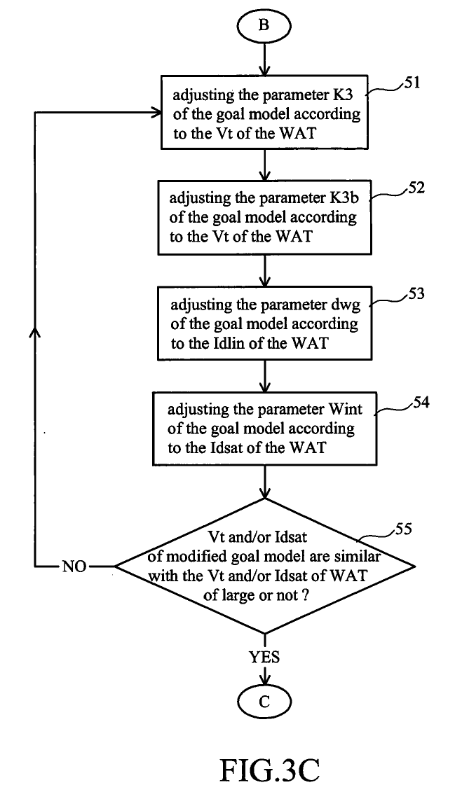

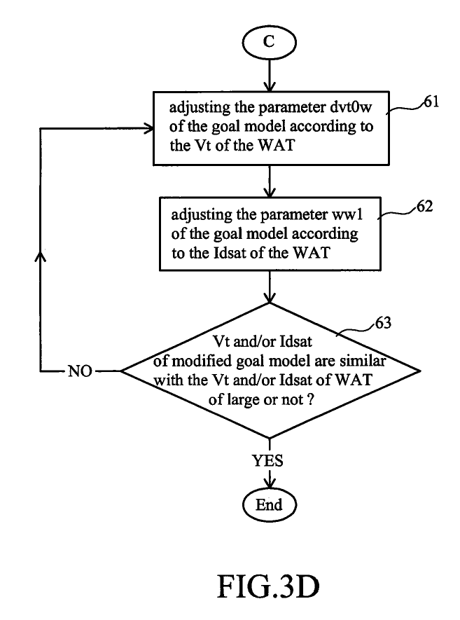

Referring to FIG. 3A through FIG. 3D, flow charts of a model modification method for the semiconductor device in accordance with an embodiment of the present invention are disclosed. The results from the WAT of large, short, narrow, and small of produced semiconductor devices can be used to adjust the parameters, such as Tox, x1, xw, vth0, u00, K1, dvt0, dvt2, rdsw, Lint, voff1, K3, K3b, dwg, Wint, dvtow and/or ww1, for generating a modified model.

The produced semiconductor devices can be divided into parts large, short, narrow, and small. The parameters of the goal model can be adjusted according to the results of the WAT for a part that is large, as shown in FIG. 3A. The parameters Tox, x1, and xw of the goal model can be replaced according to calculations of the process deviation, as shown in step 31. The parameter Vth0 of the goal model can be adjusted according to the Vt from the results of the WAT, as shown in step 32. The parameter u0 of goal model can be adjusted according to the Idlin and Idsat from the results of the WAT, as shown in step 33. The parameter K1 of the goal model can be adjusted according to the Vt from the results of the WAT, as shown in step 34. Thereafter, the parameters Vt and/or Idsat of the modified goal model and WAT can be inspected, and it can therefore be determined if the parameters of both are similar. For example, it needs to be determined whether the parameters Vt and/or Idsat of the modified goal model are similar with the Vt and/or Idsat from the results of the WAT of large or not, as shown in step 35. If the parameters of the modified goal model and WAT are not similar, steps 31 through 35 will be repeated; as well, the parameters Tox, x1, xw, vth0, u0, and/or K1 of the goal model will be adjusted. On the contrary, if the parameters of the modified goal model and WAT are similar, the following modification method will be performed.

The parameters of the goal model can be adjusted according to the results of the WAT of short, as shown in FIG. 3B. The parameter dvt0 of the goal model can be adjusted according to the Vt of the results of the WAT, as shown in step 41. The parameter dvt2 of the goal model can be adjusted according to the Vt from the results of the WAT, as shown in step 42. The parameter rdsw of the goal model can be adjusted according to the Idlin from the results of the WAT, as shown in step 43. The parameter Lint of the goal model can be adjusted according to the Idsat of the results of the WAT, as shown in step 44. The parameter Voff1 of the goal model can be adjusted according to the Ioff from the results of the WAT, as shown in step 45. Thereafter, the parameters Vt and/or Idsat of the modified goal model and WAT can be inspected, and it can therefore be determined if the parameters of both are similar. For example, it needs to be determined whether the parameters Vt and/or Idsat of the modified goal model are similar with the Vt and/or Idsat from the results of the WAT of short or not, as shown in step 46. If the parameters of the modified goal model and WAT are not similar, steps 41 through 46 will be repeated; as well, the parameters dvt0, dvt2, rdsw, Lint, and/or Voff1 of the goal model will be adjusted. On the contrary, if the parameters of the modified goal model and WAT are similar, the following modification method will be performed.

The parameters of the goal model can be adjusted according to the results of the WAT of narrow, as shown in FIG. 3C. The parameter K3 of the goal model can be adjusted according to the Vt of the results of the WAT, as shown in step 51. The parameter K3b of the goal model can be adjusted according to the Vt from the results of the WAT, as shown in step 52. The parameter dwg of the goal model can be adjusted according to the Idlin from the results of the WAT, as shown in step 53. The parameter Wint of the goal model can be adjusted according to the Idsat from the results of the WAT, as shown in step 54. Thereafter, the parameters Vt and/or Idsat of the modified goal model and WAT can be inspected, and it can therefore be determined if the parameters of both are similar. For example, it needs to be determined whether the parameters Vt and/or Idsat of the modified goal model are similar with the Vt and/or Idsat from the results of the WAT of narrow or not, as shown in step 55. If the parameters of the modified goal model and WAT are not similar, steps 51 through 55 will be repeated; as well, the parameters K3, K3b, dwg, and/or Wint of the goal model will be adjusted. On the contrary, if the parameters of the modified goal model and WAT are similar, the following modification method will be performed.

The parameters of the goal model can be adjusted according to the results of the WAT of small, as shown in FIG. 3D. The parameter dvt0w of the goal model can be adjusted according to the Vt of the results of the WAT, as shown in step 61. The parameter ww1 of the goal model can be adjusted according to the Idsat from the results of the WAT, as shown in step 62. Thereafter, the parameters Vt and/or Idsat of the modified goal model and WAT can be inspected, and it can therefore be determined if the parameters of both are similar. For example, it needs to be determined whether the parameters Vt and/or Idsat of the modified goal model are similar with the Vt and/or Idsat from the results of the WAT of small or not, as shown in step 63. If the parameters of the modified goal model and WAT are not similar, steps 61 through 63 will be repeated; as well, the parameters dvt0w and/or ww1 of the goal model will be adjusted. On the contrary, if the parameters of the modified goal model and WAT are similar, the modification method will have been achieved.

After successfully completing the steps shown in FIG. 3A to FIG. 3D, the process of the model modification has therefore been accomplished, such that the modified goal model can be defined as a modified model. Since the modified model has been modified according to the results of the WAT, the behavior of produced semiconductor devices can be accurately obtained through simulating the modified model. In the embodiment of the present invention, the parameters of the goal model are adjusted according to the results of WATs of large, short, narrow, and small in turn. However, the order of modification of large, short, narrow, and small can be altered in another embodiment.

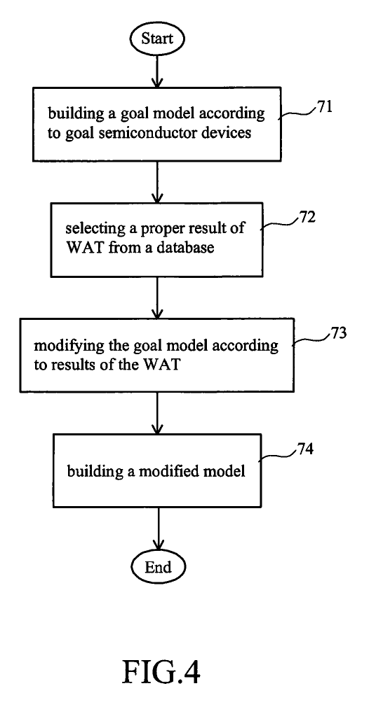

Referring to FIG. 4, a flow chart of a model modification method for the semiconductor device in accordance with another embodiment of the present invention is disclosed. After accomplishing the semiconductor process, the foundry has to perform the WAT for produced semiconductor devices, and a plurality of results from WATs can be collected. For example, a database can be established according to results of WATs for produced semiconductor devices that are manufactured by various processing conditions. Thereby, proper results the WAT can be selected from the database, and the selected WAT result of the WAT can be used to modify the goal model of the goal semiconductor device for building the modified model.

The foundry can manufacture a batch of goal semiconductor devices, and analyze the electrical properties of goal semiconductor devices for building a goal model, wherein the goal model can be used to describe the behavior of goal semiconductor devices, as shown in step 71. Thereafter, a proper result of the WAT can be selected from the database according to the processing conditions of semiconductor devices or integrated circuits provided by IC designers, as shown in step 72.

The goal model can be modified according to the results of the WAT, as shown in FIG. 3A to FIG. 3D and in step 73. A modified model can be built to correspond to the parameters of the goal model, such as Tox, x1, xw, vth0, u0, K1, dvt0, dvt2, rdsw, Lint, voff1, K3, K3b, dwg, Wint, dvtow and/or ww1, as shown in step 74.

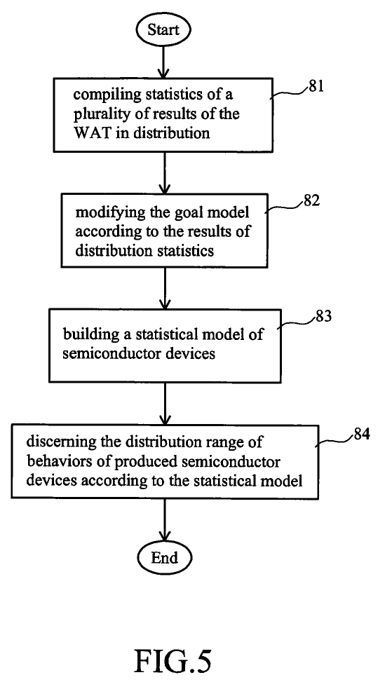

Referring to FIG. 5, a flow chart of a model modification method for the semiconductor device in accordance with another embodiment of the present invention is disclosed. IC designers or process engineers can apply the modified model to design the integrated circuit or manufacture semiconductor devices. For example, the IC designers can figure out the behavior of produced semiconductor devices from simulating the modified model, and the process engineers of the foundry can compare the goal model and modified model to be aware of any process defect and improve the processes.

Furthermore, a plurality of results of the WAT can be compiled statistics in distribution, as shown in step 81. The goal model can be modified according to the results of distribution statistics, as shown in step 82. Thereafter, a statistical model of semiconductor devices can be built through the modification of the goal model, as shown in step 83.

The distribution range of behaviors of the produced semiconductor devices can be discerned by simulating the statistical model, as shown in step 84. In another embodiment, the goal model can be modified according to a plurality of results of the WAT for getting a plurality of modified models. Moreover, a plurality of modified models can be compiled into statistics to distribute in order to build a statistical model that can be used to figure out the behavior(s) of produced semiconductor devices.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was/were chosen and described to provide the best illustration of the principles of the invention and its practical application, and to enable one of the ordinary skills in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A model modification method for a semiconductor device, comprising the steps of:
building a goal model for describing the behavior of a goal semiconductor device;
modifying said goal model according to at least one result of the WAT; and
generating a modified model for describing the behavior of a produced semiconductor device.

2. The model modification method of claim 1, comprising the step of:
starting the WAT for said produced semiconductor device.

3. The model modification method of claim 1, comprising the step of:
adjusting the parameters of said goal model.

4. The model modification method of claim 3, wherein the parameters of said goal model comprise Tox, x1, xw, vth0, u0, K1, dvt0, dvt2, rdsw, Lint, voff1, K3, K3b, dwg, Wint, dvtow and/or ww1.

5. The model modification method of claim 1, comprising the step of:
manufacturing said goal semiconductor device and analyzing the electrical properties of said goal semiconductor device.

6. The model modification method of claim 1, comprising the step of:
adjusting the parameters of said goal model according to the result of the WAT of large, short, narrow, and small.

7. The model modification method of claim 6, comprising the step of:
adjusting the parameters of said goal model according to the result of the WAT of large.

8. The model modification method of claim 7, comprising the steps of:
replacing the parameters Tox, x1, and xw of said goal model according to calculations from the process deviation;
adjusting the parameter Vth0 of said goal model according to the Vt of said result from the WAT;
adjusting the parameter u0 of said goal model according to the Idlin and Idsat of said result from the WAT;
adjusting the parameter K1 of said goal model according to the Vt of said result from the WAT; and
inspecting whether the parameters Vt and/or Idsat of the modified goal model are similar to the Vt and/or Idsat of the WAT.

9. The model modification method of claim 6, comprising the step of:
adjusting the parameters of said goal model according to the result of the WAT of short.

10. The model modification method of claim 9, comprising the steps of:
adjusting the parameter dvt0 of said goal model according to the Vt of said result from the WAT;
adjusting the parameter dvt2 of said goal model according to the Vt of said result from the WAT;
adjusting the parameter rdsw of said goal model according to the Idlin of said result from the WAT;
adjusting the parameter Lint of said goal model according to the Idsat of said result from the WAT;
adjusting the parameter Voff1 of said goal model according to the Ioff of said result from the WAT; and
inspecting whether the parameters Vt and/or Idsat of the modified goal model are similar to the Vt and/or Idsat of the WAT.

11. The model modification method of claim 6, comprising the step of:
adjusting the parameters of said goal model according to the result of the WAT of narrow.

12. The model modification method of claim 11, comprising the steps of:
adjusting the parameter K3 of said goal model according to the Vt of said result from the WAT;
adjusting the parameter K3b of said goal model according to the Vt of said result from the WAT;
adjusting the parameter dwg of said goal model according to the Idlin of said result from the WAT;
adjusting the parameter Wint of said goal model according to the Idsat of said result from the WAT; and
inspecting whether the parameters Vt and/or Idsat of the modified goal model are similar to the Vt and/or Idsat of the WAT.

13. The model modification method of claim 6, comprising the step of:
adjusting the parameters of said goal model according to the result of the WAT of small.

14. The model modification method of claim 13, comprising the steps of:
adjusting the parameter dvt0w of said goal model according to the Vt of said result from the WAT;
adjusting the parameter ww1 of said goal model according to the Idsat of said result from the WAT; and
inspecting whether the parameters Vt and/or Idsat of the modified goal model are similar to the Vt and/or Idsat of the WAT.

15. The model modification method of claim 1, comprising the step of:
inspecting said goal model and said modified model; and
modifying the process of said produced semiconductor device according to the difference between said goal model and said modified model.

16. The model modification method of claim 1, comprising the steps of:
proceeding with the distribution statistic according to a plurality of results of the WAT; and
modifying said goal model according to the results of the distribution statistic for generating a statistical model.

17. The model modification method of claim 16, wherein said statistical model is used for describing the distribution range for the behavior of said produced semiconductor device.

18. The model modification method of claim 1, comprising the steps of:
modifying said goal model according to a plurality of results of the WAT for generating a plurality of modified models; and
proceeding with the statistical analysis according to a plurality of results of the WAT for generating a statistical model.

19. The model modification method of claim 1, comprising the step of:
selecting said result of the WAT from a database.

20. The model modification method of claim 1, wherein said database comprises a plurality of results of the WAT.
